(19) United States
(12) Patent Application Publication
(10) Pub. No.: US 2007/0195880 A1
(43) Pub. Date: Aug. 23, 2007

(54) METHOD AND DEVICE FOR GENERATING DATA REPRESENTING A DEGREE OF IMPORTANCE OF DATA BLOCKS AND METHOD AND DEVICE FOR TRANSMITTING A CODED VIDEO SEQUENCE

(75) Inventors: Xavier Henocq, Mouaze (FR); Herve Le Floch, Rennes (FR)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/671,288

(22) Filed: Feb. 5, 2007

(30) Foreign Application Priority Data
Feb. 17, 2006 (FR) 0601426

(51) Int. Cl. H04N 11/04

(52) U.S. Cl. 375/240.13; 375/240.24

(57) ABSTRACT

A method of generating data representing a degree of importance of data blocks in a coded digital image of a digital video sequence coded in a hybrid predictive video coding format, said image being divided into a plurality of data blocks comprises, for the data blocks of the image, a step of determination of data representing the degree of importance of each of those data blocks on the basis of the coding or absence of coding of said data block, the determination also depending on the possible use of the data block considered for the coding of at least one data block of at least one other image of the video sequence. The invention also relates to a method of transmitting a coded video sequence.

This application claims priority of French patent application No. 0601426 filed on Feb. 17, 2006, which is incorporated herein by reference.

### FIELD OF THE INVENTION

The present invention concerns a method and device for generating data representing a degree of importance of data blocks in a coded digital image, as well as a method and device for transmitting a coded video sequence.

A favored but not exclusive application of the present invention that is particularly worthwhile is the transmission of video over a wireless network. It is directed to domestic applications of transmission from a sender to a receiver.

### BACKGROUND OF THE INVENTION

Homes increasingly tend to be equipped with domestic telecommunication networks, which may be wired networks or not. These networks transport all kinds of multimedia data, in particular, audio, video, and text data, coming from inside or outside the house.

The transport of data, in particular video, is carried out over a telecommunication network, for example a wireless network, within the house. To do this, the transport of the data, for example a compressed video, is carried out from a sender to a receiver which are both potentially mobile embedded systems.

In particular, the sender has storage capacities which enable it to store videos to transmit after their acquisition and their compression. A user may request to view these videos on a viewing unit of a receiver. For this, a wireless connection is established between the sender and the receiver in order to allow the transmission of the videos.

This transmission is carried out independently of the state of the network at the time of the transport and thus the compression of the data is independent of this transmission.

However, it is known that telecommunication networks, in particular wireless networks, do not provide conditions and guarantees of transmission that are stable over time.

This is because, during a transmission of data, the state of the telecommunication network may vary and pass from a state that is compatible, for example with an coded video to transmit, to a state that no longer enables transmission without losses.

Furthermore, the receiver is a device which may have very diverse capacities. More particularly, it may be a portable device having little processing, memory, and display capacity, such as a mobile telephone or a device of the computer kind.

However, at the time of the coding of the video, there is little probability that the sender has generated a video compatible with all of these constraints.

It is consequently necessary to adapt the video to these constraints.

It is known to perform a first exchange of items of information between the sender and the receiver enabling the sender to know the nature of the receiver, its capacities and the wishes of the user. These first items of information describe the receiver in terms of calculation capacity, display capacity and decoding capacity.

Other items of information may be exchanged during the transmission. In contrast to the first series of items of information, these other items of information will be regularly updated. They describe, in particular, the evolution of the state of the network from the point of view of the receiver.

The analysis of these other items of information may incite the sender to adapt the video, and, in this respect, several types of adaptation may be made. It is possible, for example, to change the rate of the video, its resolution or the number of images displayed per second.

As regards the rate, it can be considered that there are three types of method enabling the rate to be adjusted.

A first method is linked to transcoding. Transcoding consists of operating on a coded video in relation to the quantization of the data. This method may prove complex since it requires the taking into account of the inter image dependencies when the images are compressed in predictive mode.

A second method concerns the scalability and consists, at the time of the compression of a video, of creating a bitstream constituted by several overlapping versions of a video. To do this, it is necessary to choose, at the time of transmission, the portion of the bitstream the best adapted to the context of the transmission.

A third method is linked to the organization of the bitstream. This method which is close to the preceding one consists of organizing the bitstream so as to facilitate a possible transcoding operation.

None of these methods however makes it possible to perform a transmission of data to the receiver which is adapted to the network. More particularly, transcoding leads to relatively complex processing operations that are difficult to implement in an embedded system. As for the tools of scalability available in the video standards, these are not available when using a simple profile such as the use of a profile in accordance with the MPEG-4 part 2 standard. Finally, there is little probability that a simple organization of the bitstream will suffice to adapt the transmission of the video to the network.

From document U.S. Pat. No. 6,707,944 there is also known a method in which the video objects of a video sequence are identified, and with each object a priority is attributed. For example, in a video sequence representing a tennis match, the object “player” has a higher priority than the object “screen background”. Next, when it is necessary to degrade the video, the objects are decoded according to their priority.

Furthermore, the simple profile of the standard MPEG-4 part 2 provides a hybrid video coding method based on blocks.

In a hybrid predictive video coding scheme with motion compensation based on blocks and coding by transformation, each image of a sequence is divided into blocks of fixed size and each block is then processed more or less independently. In general, the size of each block is 8*8 pixels.

The designation hybrid means that each block is coded with a combination of motion compensation and coding by transformation.

Thus a block is initially predicted on the basis of a block of a preceding image also termed reference image. This prediction is termed a motion estimation. It consists of estimating the position of the block that is the closest visually to the block in the reference image.

The displacement between the reference block and the current block is represented by a motion vector.

Thus, motion compensation consists of predicting the current block from the reference block and from the motion vector.

Next, the prediction error between the original block and the predicted block is coded with a discrete cosine transform (DCT), quantized and converted into the form of binary codewords using variable length codes (VLC).

This transformation makes it possible to represent an image in frequency form. In general it applies to blocks of pixels of size 8*8 pixels and makes it possible to obtain blocks of DCT coefficients of the same size. Each coefficient represents a frequency band referred to as spatial frequency band. Since the human visual system is more sensitive to low spatial frequencies than to high spatial frequencies, a data compression that is of low detectability to the eye may be obtained by limiting the quantity of binary data allocated to the coding of the high frequency coefficients.

The role of the motion compensation is to use temporal correlations between the successive images to increase the compression.

With regard to the discrete cosine transform, this makes it possible to reduce the spatial correlations in the error blocks.

After the discrete cosine transform and the quantization, a majority of the high frequencies is reduced to 0. As the human visual system has low sensitivity to high spatial frequencies, the impact on visual appearance remains low.

Next, the coefficients of the discrete cosine transform are scanned in zig-zag from the low frequencies to the high frequencies in order to constitute a first bitstream.

The presence in this bitstream of numerous 0's is taken advantage of by a variable length code to reduce the size. Such an implementation is carried out, among others, by runlength coding.

When a temporal prediction has succeeded and the rate generated by the prediction error remains below that of an original macroblock coded without motion compensation, this coding mode, generally termed INTER coding, is kept.

It will be noted that a macroblock is generally defined as a set of four square blocks of 8*8 pixels of an image.

In practice, motion estimation is very often applied to a macroblock.

Video coders generally use macroblocks of size 16*16 pixels. As the motion vectors of adjacent macroblocks are most often close, they may be predictively coded with respect to the macroblocks already coded.

An image containing macroblocks coded according to the INTER coding mode is termed a P image.

Where the rate generated by the prediction error is too high, a discrete cosine transform and a runlength coding are directly applied to the block. This coding mode is termed INTRA coding and the image entirely coded with this mode is termed INTRA image or I image.

This type of coding is used for the first image of the sequence, but also for other images with the aim of limiting the propagation of the prediction error and the propagation of losses.

This coding mode is also used to provide functionalities such as random access, fast forward or rewind in a video sequence.

The number of INTRA images is nevertheless generally limited to obtain better compression rates.

The majority of the images of a video sequence is thus coded in P coding mode. However, it is permitted to insert INTRA macroblocks in a P image.

Nevertheless, it is possible for a video coded at a given rate not to be compatible with the state of a network, in particular if the latter has a rate less than the initial rate of the video.

A first solution consists of transmitting the video without however carrying out particular processing operations. In this case, congestion may arise and cause data losses. The robustness of the decoder is then relied on to give the received video an acceptable appearance.

This method is little effective in the case of videos coded in predictive mode. This is because, if a macroblock serving for the prediction is lost, its loss can propagate to all the macroblocks directly or indirectly using that macroblock as reference macroblock.

A second solution is based on the use of error control methods. These may react a priori by anticipating possible errors, or a posteriori, by attempting to counter the effect of the errors.

Certain methods of a posteriori error control, such those presented in Appendix I of the H263+ standard described by G. Sullivan in the paper entitled “Draft text of recommendation H.263 version 2 (H263+) for decision”—ITU-T, of March 1999, accessible at the following address http://ftp3.itu.int/av-arch/video-site/h263plus/, provide a method of error control for a scheme of video transmission over a network using RTP (Real Time Protocol).

This scheme is based on sending packets back from the receiver to the sender containing the identifiers of the lost packets. This information enables the sender to deduce which macroblocks are liable to suffer from the loss of a packet during their reconstruction.

The macroblocks suffering greatly from the loss of a packet are then refreshed in INTRA coding mode.

The metric making it possible to estimate the impact of a loss proposed in this schema has the drawback of taking into account only the direct dependencies between the macroblocks.

However, indirect dependencies may exist. For example, a macroblock of an image at the time t+2 may be predicted from a macroblock of the image at the time t+1 which is itself predicted from a macroblock of the image at the time t.

Furthermore, this metric necessitates calculating the sum of the absolute values of the inter pixel differences between macroblocks of successive images. For this, it is necessary to keep the values of the pixels of all the macroblocks of several images, which gives rise to a high storage cost.

Another similar method of error control based on the use of packets sent back is proposed in the paper “Hybrid Sender and Receiver Driven Rate Control in Multicast Layered Video” of F. Le Léannec, C. Guillemot, published in ICIP2000 and accessible at the address http://www.irisa.fr/temics/equipe/leleannec/.

According to this method, the calculation of a metric of relative importance of the macroblocks is replaced by the construction of a graph of dependency between the macroblocks. When the sender identifies a lost macroblock, it is capable by means of this graph to deduce which are the macroblocks concerned in the successive images.

However, the management of the dependency graph may prove complex, especially if inter macroblock dependencies are considered that are far apart.

These two methods of error control have the drawback of reacting after losses have occurred in order to reduce their propagation.

According to still another method, a video is adapted to the decoding capacities of the client.

Thus, on the sender side, each image of the video is cut up into several semantic regions and a priority is then attributed to each semantic region.

On the receiver side, if it is considered that the video is too complex to be decoded, it is decided to degrade it in order to reduce its complexity.

The priorities attributed make it possible to degrade the video unequally, so as to maintain a good quality in the important regions.

It should however be noted that it is difficult to attribute the degree of priority automatically since this relies on semantic knowledge of the images, which is a drawback.

Furthermore, no method is proposed to reduce the complexity of the videos.

Finally, the data are deleted at the receiver.

This approach is not optimal since data that cannot be processed by the receiver are nevertheless sent on the network

### SUMMARY OF THE INVENTION

Given the above, it would consequently be worthwhile to be able to carry out a transmission of data taking into account the bandwidth available on the network and avoiding at least some of the aforementioned drawbacks.

The object of the present invention is firstly to provide a method of generating data representing a degree of importance of data blocks in a coded digital image of a digital video sequence coded in a hybrid predictive video coding format, said image being divided into a plurality of data blocks, characterized in that the method comprises, for the data blocks of the image, a step of determination of data representing the degree of importance of each of those data blocks on the basis of the coding or absence of coding of said data block, the determination also depending on the possible use of the data block considered for the coding of at least one data block of at least one other image of the video sequence.

The method of generating data representing a degree of importance of data blocks in a coded digital image of a digital video sequence coded in a hybrid predictive video coding format according to the invention makes it possible to estimate the importance of a block of an image of a video sequence by taking into account the direct and indirect dependencies between the data blocks of images of a sequence.

This is because the data representing a degree of importance of a data block reflects the importance of a data block with respect to other data blocks of other images.

This method enables, furthermore, the determination of the degree of importance while avoiding the storage in memory of several decoded images.

According to a feature, in case of coding of the data block, the determination is furthermore a function of the coding mode used.

According to a particular feature, the coding mode of said data block is an INTRA or INTER coding mode.

According to a possible feature, the determination depending on the possible use of the data block is carried out on a set of images comprising at least one image consecutive to the image considered in the sequence.

According to another possible feature, the determination of data representing the degree of importance I_{MB}_{_{t,i}} is carried out by means of the following equation:

$${I}_{{MB}_{t , i}} = α {\sum }_{j} ( \frac{1}{{σ}_{{MB}_{t + 1 , j}}} \times \frac{{p}_{{MB}_{t + 1 , j}} ∈ {MB}_{t , i}}{{P}_{T} \times {I}_{{MB}_{t + 1 , j}}} )$$

where the block t+1,j is at least partially predicted from the block t,i,

σ_{MB}_{_{t+1,j}} is the variance of the prediction error for the current block,

p_{MB}_{_{t+1,j}}_{εMB}_{_{t,i}} is the number of pixels of the reference block MB_{t,i} used on prediction of the current block MB_{t+1,j},

P_{T} is the number of pixels in a block and

α is a multiplying factor.

The determination of data representing the degree of importance according to the above equation makes it possible to avoid having to keep the values of the pixels of the data blocks and thus to reduce the memory space used.

This formula is recursive since the importance of a data block in an image t is a function of the importance of the data blocks in the image t+1.

According to another feature the multiplying factor a takes a first value when the coding mode of said data block is an INTRA coding mode and a second value when the coding mode of said data block is a coding mode different from the INTRA mode, the first value being greater than the second value.

According to a feature, the method comprises a step of generating a map comprising the data representing the degree of importance of data blocks of the image considered.

According to this feature, a map of importance is associated with the image, containing the data representing the degree of importance of data blocks of that image.

According to a possible feature, the degree of importance of a data block increases with the use of that data block for the coding of data blocks of other images.

According to another feature, the degree of importance of a data block coded independently of other data blocks of other images is higher than that of a data block coded in a manner dependent on other data blocks of other images.

According to another possible feature, the non-coded data blocks of the image have a low degree of importance.

This is because the non coded data blocks may be used to code other data blocks of other images. For this reason, a low degree of importance is attributed to these non-coded data blocks.

The object of the present invention is also to provide a method of transmitting a video sequence coded in a hybrid predictive video coding format in a communication network, the video sequence being composed of a plurality of digital images, each image being divided into a plurality of data blocks, characterized in that, with data blocks of the images there are associated data representing a degree of importance of each of the data blocks, the method comprising the following steps applied to images of the video sequence to transmit:

estimating the bandwidth of the communication network,

comparing the size of the image to transmit with the estimated bandwidth,

according to the result of the comparison, deciding as to the determination of a sub-set of data blocks of the image each having a degree of importance chosen from the highest degrees of importance, such that the size of that sub-set is compatible with the estimated bandwidth, and

according to the result of the comparison, transmitting the image or the determined sub-set of data blocks of the image.

During the transmission, if the rate of the video is greater than the available bandwidth on the network, a sub-set of data blocks is determined such that the sub-set is of size less than the available bandwidth.

In this way, the rate of the video sequence is reduced.

The determination of this sub-set is carried out with a low calculation cost.

Similarly, the compatibility of the bitstream of the video sequence with any decoder complying with the standards is ensured.

According to a feature, the degree of importance is determined according to the method of generating data briefly set forth above.

According to another feature, the method comprises a step of coding blocks in video packet form.

According to a feature, the determination of a sub-set of data blocks of the image comprises the deletion of data blocks in increasing order of the degrees of importance.

This process of deletion of data blocks is carried out at a low calculation cost. This is because, as the degree of importance of each of the data blocks of an image is possessed, it is easy to determine the data blocks of least importance.

According to one embodiment, the deletion of the data blocks of increasing degree of importance is carried out so long as the data representing the degree of importance of the data blocks are less than a predetermined threshold.

According to another embodiment, the deletion of the data blocks of increasing degree of importance is carried out so long as the size of that sub-set of data blocks of the image is not compatible with the estimated bandwidth.

In a complementary manner, the invention also concerns a device for generating data representing a degree of importance of data blocks in a coded digital image of a digital video sequence coded in a hybrid predictive video coding format, said image being divided into a plurality of data blocks, characterized in that the device comprises means for determination of data representing the degree of importance of data blocks on the basis of the coding or absence of coding of said data block, the determination also depending on the possible use of the data block considered for the coding of at least one data block of at least one other image of the video sequence.

This device has the same advantages as the method of generating data representing a degree of importance of data blocks in a coded digital image of a digital video sequence coded in a hybrid predictive video coding format briefly described above.

The object of the present invention is also to provide a device for transmitting a video sequence coded in a hybrid predictive video coding format in a communication network, the video sequence being composed of a plurality of digital images, each image being divided into a plurality of data blocks, characterized in that, with data blocks of the images there are associated data representing a degree of importance of each of the data blocks, the device comprising the following means applied to images of the video sequence to transmit:

estimating means adapted to estimate the bandwidth of the communication network,

comparing means adapted to compare the size of the image to transmit with the estimated bandwidth,

deciding means adapted to decide, according to the result of the comparison, as to the determination of a sub-set of data blocks of the image each having a degree of importance chosen from the highest degrees of importance, such that the size of that sub-set is compatible with the estimated bandwidth, and

transmitting means adapted to transmit, according to the result of the comparison, the image or the determined sub-set of data blocks of the image.

This device has the same advantages as the method of transmitting a video sequence coded in a hybrid predictive video coding format in a communication network briefly described above and they will not be repeated here.

According to other aspects, the invention also concerns computer programs for an implementation of the methods of the invention described briefly above.

### BRIEF DESCRIPTION OF THE DRAWINGS

Other aspects and advantages of the present invention will appear more clearly on reading the following description given solely by way of non-limiting example and made with reference to the accompanying drawings in which:

FIG. 1 represents a coding algorithm according to the invention;

FIG. 2 illustrates a map comprising data representing the degree of importance of the macroblocks of an image according to the invention;

FIG. 3 represents an algorithm for updating a window for analysis of the images;

FIG. 4 represents an algorithm for determining the degree of importance of a macroblock of an image according to the invention;

FIG. 5 illustrates a system for transmitting a video in accordance with the invention;

FIG. 6 represents an algorithm for transmitting a video according to the invention;

FIG. 7 represents an algorithm for macroblock deletion from an image prior to its transmission according to the invention;

FIG. 8 is a diagram of an apparatus in which the invention is implemented.

### DETAILED DESCRIPTION

The description of the invention is made with reliance on the MPEG-4 part 2 video coding standard as described in the document entitled “ISO/IEC 14496-2:2003.Information technology—Coding of audio visual objects. part 2: visual” (ISO/IEC JTC 1/SC29/WG11 N5546), Pattaya, March 2003. However, other standards such as MPEG-2 or H263 and H264 may be used for the implementation of the invention.

A description will first of all be given of the method of coding a video sequence composed of a plurality of digital images, each divided into blocks or macroblocks of digital data, before carrying out the transmission of that video.

The coding and transmitting methods are described using macroblocks as decomposition of the image, however these processes are applicable to other units of decomposition, such as blocks.

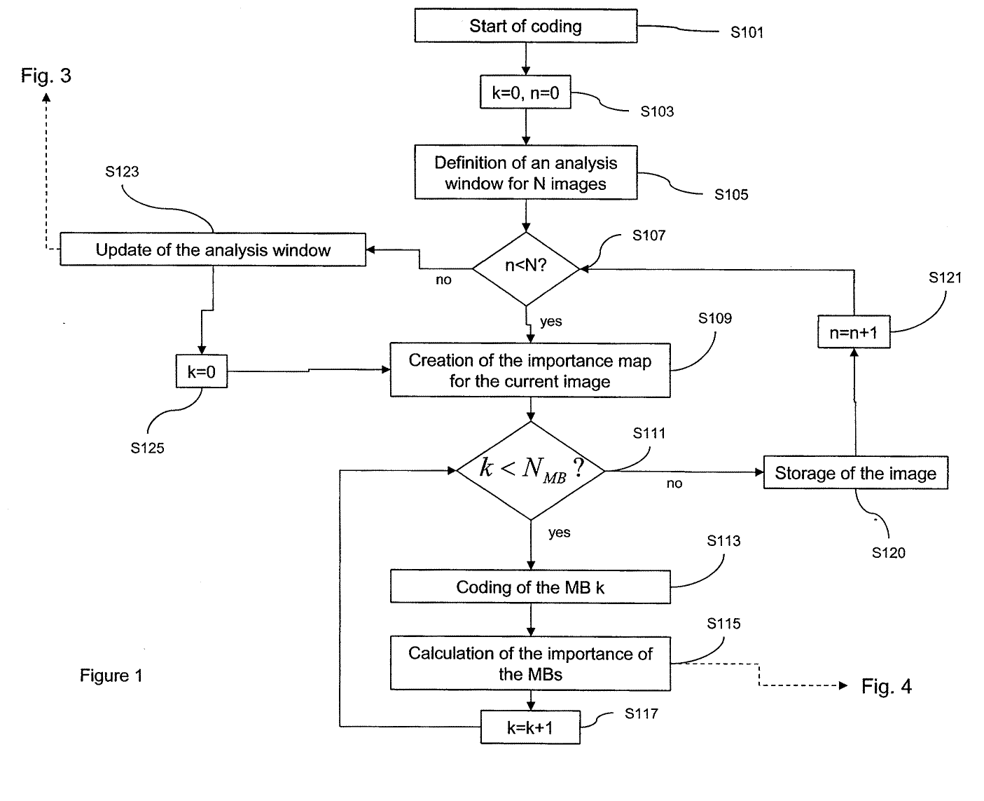

With reference to FIG. 1, a coding algorithm is described. The latter is implemented, for example, by an embedded system such as a video camera.

This system comprises a unit for image acquisition, a calculation unit, a video coder complying with the MPEG-4 part 2 standard and a storage unit.

The coding process commences at step S101 which is followed by the initialization of the variables k and n to 0 at the step S103.

The variable k makes it possible to store and identify the macroblock in course of being processed of the current image and the variable n identifies the image in course of being processed (current image) in a window for analysis of a plurality of images of the video sequence.

The step S103 is followed by the step S105 consisting of defining a sliding window for analysis of images, this window comprising a number N of images, with N greater than or equal to 1.

This step is followed by the step S107 during which it is tested whether there remain images of the window to go through on going through the images of the window defined at step S105.

In the case in which the response to this test is positive, the algorithm continues with the step S109 during which an importance map is created comprising data representing the degree of importance of macroblocks for the current image and those data are initialized with a value by default.

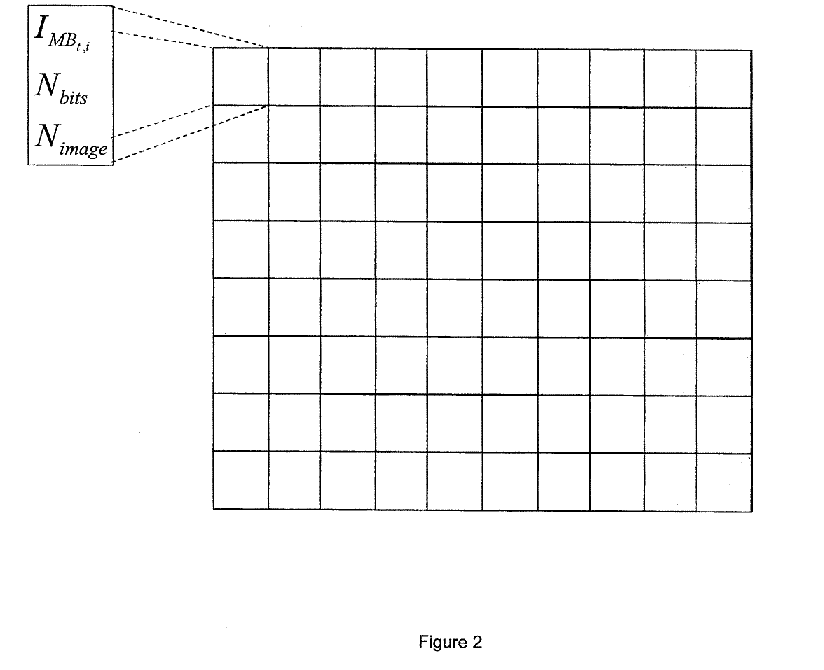

This map of data that represent the degree of importance, illustrated in FIG. 2, contains, for each one or at least some of the N_{MB} macroblocks of the image, a measurement of the degree of importance of the macroblock I_{MBt,i}, the number of bits N_{bits} used on coding the macroblock and the number of images N_{image} concerned by the macroblock considered.

The degree of importance of a macroblock represents the importance of that macroblock in the decoding method.

This step S109 is followed by the step S111 during which it is tested whether there remain macroblocks of the image to code.

If the result of this test is negative step S111 is followed by step S113 during which the coding of the current macroblock MBₖ is carried out according to the processes defined by the MPEG-4 standard.

Each macroblock may be coded in the form of a “slice” (“video packet” in the terminology used in the MPEG-4 standard).

Coding in the form of a slice for each macroblock is in no way obligatory. However, in the context of video of MPEG-4 type, this coding makes it possible to simplify the process of transcoding implemented during the transmission of the video.

This is because the coding of the slices makes it possible to ensure that all the macroblocks of an image are totally independent. Thus, if a macroblock is deleted prior to the sending of the image in order to reduce the size of the image, this in no way affects the other macroblocks of the image.

During this coding step, the coding mode of the current macroblock MBₖ is chosen. It may be recalled that a macroblock may be coded in INTRA or INTER mode or not be coded, a macroblock that is not coded being termed “skipped”.

The MPEG-4 standard specifies that a skipped macroblock is stored with neither motion vector nor discrete cosine transform (DCT) coefficient. Thus, on decoding that macroblock, the decoder takes again the macroblock situated at the same position in the preceding image.

It should be noted furthermore that the motion vector associated with an INTER macroblock makes it possible to deduce the dependencies between that macroblock and the macroblocks of the reference image.

Step S113 is followed by step S115 during which determination of the degree of importance of the current macroblock is carried out.

For this, the degree of importance of the macroblock MBᵢ in the image t is estimated by means of the following formula:

$$\begin{matrix}{I}_{{MB}_{t , i}} = α {\sum }_{j} ( {I}_{{MB}_{t , i} \to {MB}_{t + 1 , j}} \times {I}_{{MB}_{i + 1 , j}} ) \\ = α {\sum }_{j} ( \frac{1}{{σ}_{{MB}_{t + 1 , j}}} \times \frac{{p}_{{MB}_{t + 1 , j}} ∈ {MB}_{t , i}}{{P}_{T} \times {I}_{{MB}_{t + 1 , j}}} )\end{matrix}$$

where φ_{MB}_{_{t+1,j}} is the variance of the prediction error for the current macroblock,

p_{MB}_{_{t+1,j}}_{εMB}_{_{t,i}} is the number of pixels of the reference macroblock MB_{t,i} used on prediction of the current macroblock MB_{t+1,j},

P_{T} is the number of pixels in a macroblock, and

α is a multiplying factor.

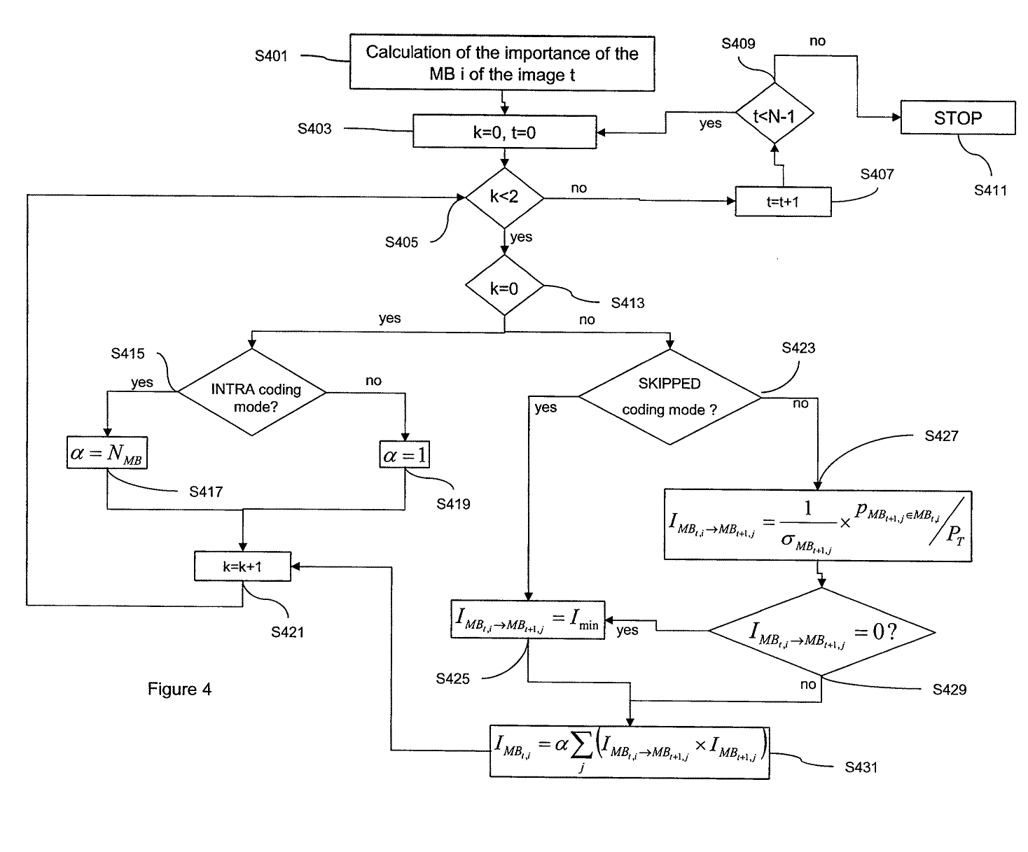

The multiplying factor a makes it possible to take into account the fact that the processed macroblock is an INTRA or INTER macroblock, as explained later with reference to FIG. 4.

The expression I_{MB}_{_{t,i}}_{→MB}_{_{t+1,j}} will also be explained in the description of FIG. 4.

It will be noted that the macroblock t+1,j is at least partially predicted from the macroblock t,i and that the index j enables summing to be made over all the macroblocks using the macroblock MB_{t,i} as reference.

Moreover, the use of the variance of the prediction error rather than the sum of the absolute values of the inter pixel differences between two macroblocks makes it possible to avoid having to store the pixel values of the macroblocks and thus to reduce the memory space used.

The above formula is recursive since the degree of importance of a macroblock MBᵢ in the image t is also a function of the degree of importance of the macroblocks MBⱼ in the image t+1.

Thus, the final values of the degree of importance of the macroblocks of the image t is known when all the N images which follow the image t in the sliding window are coded.

The method of determining the degree of importance is described later with reference to FIG. 4.

Step S115 is then followed by step S117 which increments the value of the variable k by one unit so as to pass to the following macroblock.

Step S111, already described, is then returned to.

If, at the time of the test carried out at step S111, the number of macroblocks processed in the image reaches the total number of macroblocks in the image, step S120 is passed on to during which the image is stored in the storage unit.

Step S120 is followed by step S121 during which the variable n is incremented by one unit, which makes it possible to pass on to the following image.

Step S121 is then followed by the step S107 already described.

If, at this step, the number of images processed is greater than the number of images in the sliding window, step S123 is passed on to for updating the window for analysis of the images.

At this step, it is considered that the generation of the map comprising data representing the degree of importance of the macroblocks for the first image of the window is terminated.

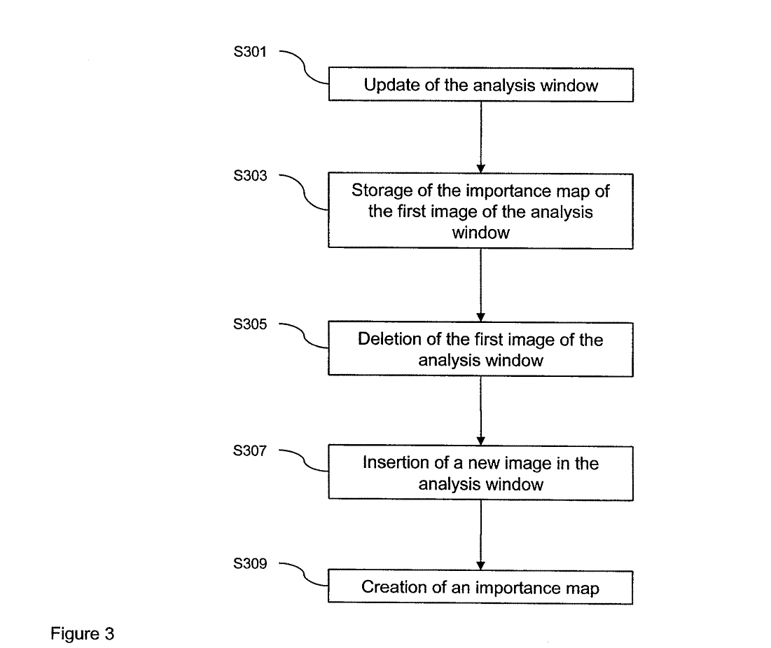

This updating will now be described in more detail with reference to FIG. 3.

The updating algorithm commences at step S301.

Next, at step S303, storage is made, on a storage unit of a server or of the sender, of the importance map comprising data representing the degree of importance of macroblocks of the image, this image being the first image of the analysis window.

During the following step S305, the first image is withdrawn from the window.

A new image is then inserted at the end of that window during the step S307 which follows step S305.

Next, a new importance map is created comprising data representing the degree of importance of macroblocks of that new image during step S309, thus ending the algorithm of FIG. 3.

Returning to step S123 of FIG. 1, this is followed by step S125 during which the variable k is initialized to the value 0.

According to a variant embodiment, if each macroblock corresponds to a slice, the coder can then force the quantization parameters between two consecutive macroblocks to take values which are at most different by plus or minus two (±2), so as to be compatible with the MPEG-4 standard in case of deletion of the slice headers during transmission.

The determination of the degree of importance according to the invention will now be described with reference to FIG. 4.

The algorithm commences at step S403 by the initialization of the variables k and t with the value 0.

The variable k is a counter specific to the algorithm and enabling the execution of both branches of that algorithm.

The variable t represents an index of the image in course in the image window.

Step S403 is followed by step S405 during which it is tested whether the variable k has a value less than 2.

If, at step S405, the result is negative, the variable k thus having a value greater than 2, then step S405 is followed by step S407 during which the value of the variable k is incremented in order to pass on to the following image.

This step S407 is followed by step S409 consisting of verifying whether all the images of the window have been tested.

In the affirmative, the algorithm is terminated (step S411).

In the opposite case, step S409 is followed by step S403 already described.

Returning to step S405, when the variable k has a value less than 2, step S405 is followed by step S413 during which the value of the variable k is tested.

If this variable k is equal to the value 0, step S415 is passed on to. In the opposite case, the step S423 described later is passed on to.

At step S415, the coding mode of the current macroblock is tested in order to determine whether that macroblock is coded with an INTRA coding mode or not.

If the result of this test is positive, that is to say that the current macroblock is coded with an INTRA coding mode, step S415 is followed by step S417.

In the opposite case, step S415 is followed by step S419 which will be described later.

During step S417, the factor a takes the value N_{MB}, which is the number of macroblocks in an image, such that, when the current macroblock is coded with an INTRA coding mode, the degree of importance thereof takes a high value.

Returning to step S419, the factor a takes the value 1, such that the macroblock which is not coded in an INTRA coding mode will have a lower degree of importance.

Note also that on the first passage in that branch of the algorithm for a given macroblock MB_{t,i}, the value of the degree of importance is initialized to 0.

The two steps S417 and S419 are next followed by the step S421 consisting of incrementing the variable k by one unit so as to execute the second branch of the algorithm.

Step S421 is followed by the previously described step S405.

Returning to step S413, when the variable k has a value different from 0, this step is followed by the step S423 consisting of determining whether the coding mode of the current macroblock is of skipped type or not.

If the coding mode of the macroblock is of skipped type then step S423 is followed by step S425.

In the opposite case, step S423 is followed by step S427 which will be described later.

During step S425, a low degree of importance is allocated to the current macroblock of skipped type.

More particularly, the current macroblock is allocated with the degree of importance relative to the use of that macroblock for the coding/decoding of macroblocks of other images, i.e. a predetermined minimum value (I_{MB}_{_{I,j}}_{→MB}_{_{t+1,j}}=Iₘᵢₙ).

Concerning step S427, determination is made of the degree of importance according to the following formula:

$${I}_{{MB}_{t , i} \to {MB}_{t + 1 , j}} = \frac{1}{{σ}_{{MB}_{i + 1 , j}}} \times \frac{{p}_{{MB}_{i + 1 , j} ∈ {MB}_{t , i}}}{{P}_{T}} ,$$

where the macroblock t+1,j is the macroblock of the image t+1 at the position j. It is possible to examine all the macroblocks of the image t+1, however according to a specific embodiment, examination is made only of the macroblocks of the image t+1 which are, at least partially, predicted from the macroblock MB_{t,i}.

This formula determines, for a macroblock coded with an INTRA or INTER coding mode, the importance of the current macroblock during the coding of the macroblocks of other images. In this way, the more a macroblock coded with an INTRA or INTER mode is used for coding macroblocks of images following the current image, the higher the degree of importance of that macroblock.

Step S427 is then followed by step S429 which tests the value of the degree of importance of the current macroblock.

If that value is equal to 0, step S429 is followed by step S425 already described. This is because the value taken by this calculation must be at least the predetermined value Iₘᵢₙ.

In the opposite case, step S429 is followed by step S431 consisting of calculating the final value of the degree of importance of the current macroblock.

In the same way, step S425 is followed by the step S431.

During this step S431, the importance value I_{MB}_{_{t,i}} of the current macroblock is updated by means of the following formula:

$${I}_{{MB}_{t , i}} = α {\sum }_{j} ( {I}_{{MB}_{t , i} \to {MB}_{t + 1 , j}} \times {I}_{{MB}_{i + 1 , j}} )$$

In practice, I_{MB}_{_{t,i}} is initialized to the value 0 and then, for each macroblock of index j of the image t+1 processed which is at least partially predicted from MB_{t,i}, the following operation is carried out:

I_{MB}_{_{t,i}}=I_{MB}_{_{t,i}}+α(I_{MB}_{_{t,i}}_{→MB}_{_{t+1,j}}×I_{MB}_{_{t+1,j}})

Note that alternatively, a multiplication can be carried out by the multiplying factor α only after having processing the complete set of the macroblocks dependent on the current macroblock in the set of images to process.

It is to be noted that two particular cases are to be considered.

On the other hand, as a macroblock coded with an INTRA coding mode is very important, the degree of importance associated with that macroblock must take a value very much greater than that of a macroblock coded with the INTER coding mode. This differentiation is achieved by virtue of the initialization of the multiplying factor a to the value N_{MB} during the step S417.

On the other hand, as a macroblock of skipped type is of low importance, a degree of importance is attributed to it of predetermined minimum value Iₘᵢₙ.

This is because, if such a macroblock is deleted from the bitstream, the decoder is capable of replacing it efficiently by conventional methods of concealing loss.

It is also to be noted that, if a macroblock only affects a limited number of images in a sliding window, that macroblock has a short-term influence.

The value of the importance calculated by the equation of step S431 of FIG. 4 tends to 0 when a macroblock no longer affects an image.

Consequently, this equation does not make it possible to differentiate the long-term dependencies from the short-term dependencies.

Thus, for example, a first macroblock which affects two images and a second macroblock which affects four images are both liable to have their importance converge towards 0, whereas the second macroblock is more important than the first.

In order to better differentiate between the short-term and long-term dependencies, it is considered that the value of the degree of importance takes the predetermined value Iₘᵢₙ as soon as a macroblock no longer directly or indirectly affects an image.

Note that the value Iₘᵢₙ is obtained using training sequences such that the value Iₘᵢₙ is the minimum value of the non-nil importance measurements found.

Step S431 is then followed by the previously described step S421.

The coding process described previously is independent from the transmission process which will now be described.

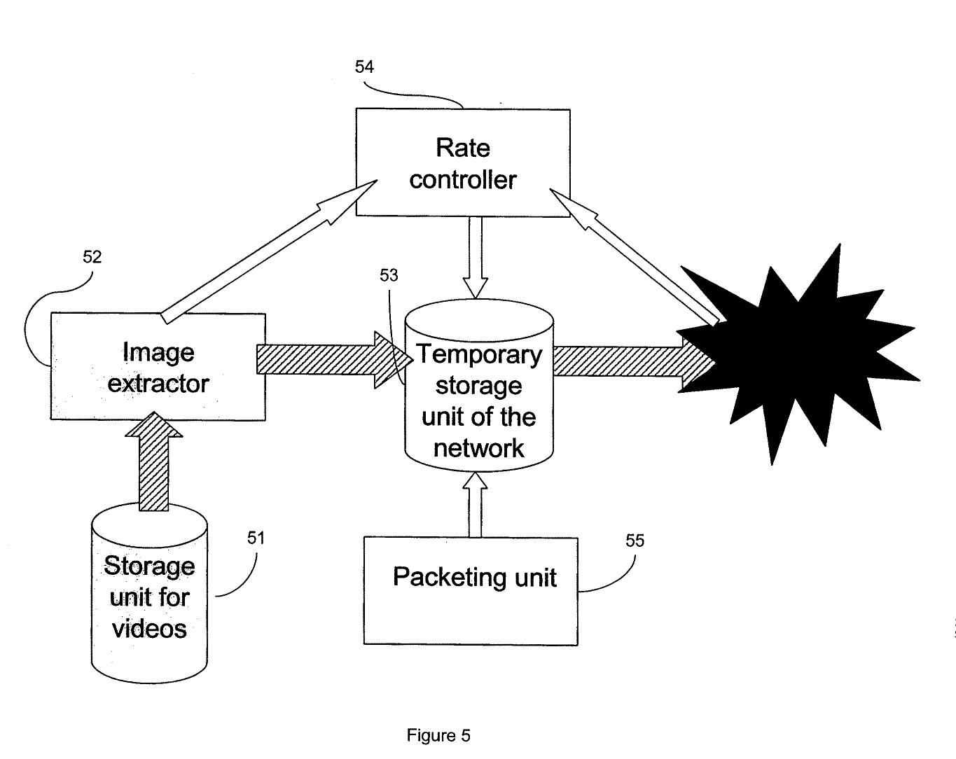

The transmission system illustrated in FIG. 5 and which enables videos to be transmitted, uses, for example a transport layer based on the Real Time Protocol (RTP), as described in the document entitled “RFC 1889—RTP: A Transport Protocol for Real-Time Applications”.

This transmission system is constituted by five main elements. First of all, the system comprises a storage unit 51 in which the videos are stored. The storage unit is, for example a hard disk or a memory card.

An image extractor 52 constitutes a second element of the system and its object is to extract the images of the videos from the storage unit. This image extractor also extracts the map created beforehand comprising the data representing the degree of importance of macroblocks of each image. On the basis of this map, the size of each image is calculated by adding the sizes of the macroblocks composing the image. The image extractor is, for example, produced in the form of a computer program.

A third element of the system is a temporary storage unit 53 which receives the images extracted from the video storage unit. This storage unit is for example a RAM memory.

Next, a rate controller 54 is given the task of comparing the size of the images to the rate of the available bandwidth on the network and to delete, if necessary, macroblocks from the temporary storage unit 53.

The rate controller receives Real-time Transfert Control Protocol (RTCP) reports enabling it to calculate the available bandwidth on the network.

The method described in the document “Equation-based Congestion Control for Unicast Applications: the Extended Version” by S. Floyd, M. Handley, J. Padhye, J. Widmer, ACM SIGCOMM 2000, Stockholm, published in August 2000, may be used to estimate the bandwidth.

The rate controller is, for example, produced in the form of a computer program.

Finally, the system comprises a packeting unit 55 given the task of encapsulating the macroblocks in packets of RTP type.

The packeting unit 55 is for example implemented in the form of a computer program.

A network interface is also available, which may be implemented in the form of a program or a network card.

This transmission system may be embedded in the same video coding system as that described previously.

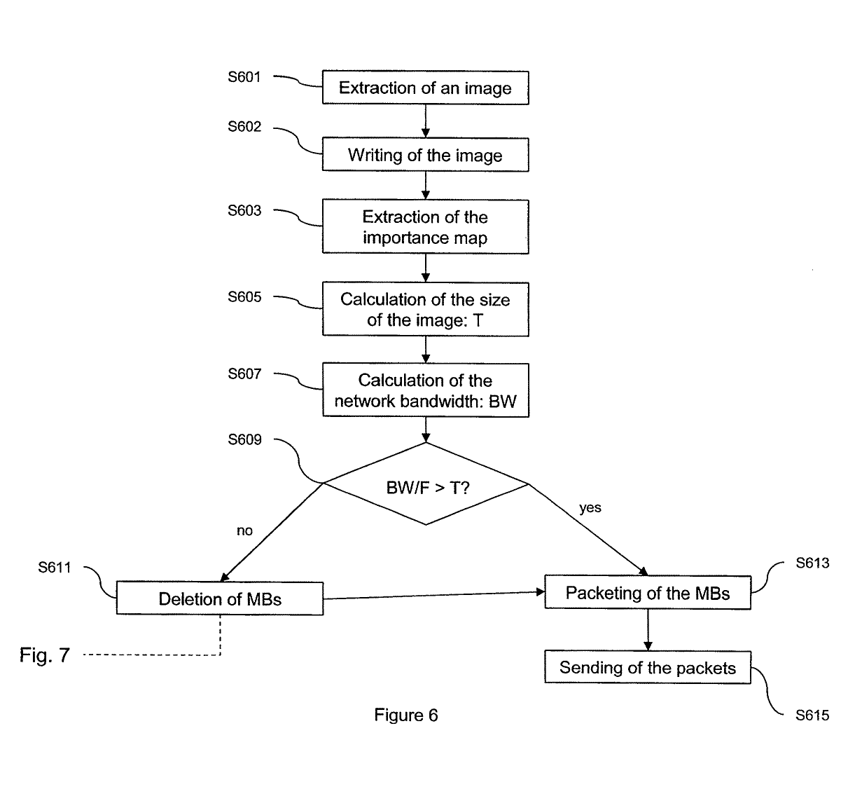

The procedure for transmitting the images of a video illustrated by the diagram of FIG. 6 commences with step S601. At this step, an image is extracted from the storage unit 51.

This image is then stored in the temporary storage unit 53 at the following step S602.

This step is followed by the step S603 consisting of extracting from the storage unit the map comprising data representing the degree of importance of the macroblocks of the image.

On the basis of this map, the size T of the image to transmit is calculated at step S605.

At the following step S607, the bandwidth BW available on the network is estimated.

The bandwidth is divided by the frame rate F of the video sequence and the value obtained is compared to the size T of the image to transmit (S609).

If the size T of the image is less than that value obtained, the available bandwidth is sufficient to send the image.

The image is then put into packets at step S611, and then those packets are transmitted to the receiver at step S613.

In the opposite case, that is to say if the size T of the image is greater than the result of the division, the image cannot be sent as it is without the risk of creating congestion in the network.

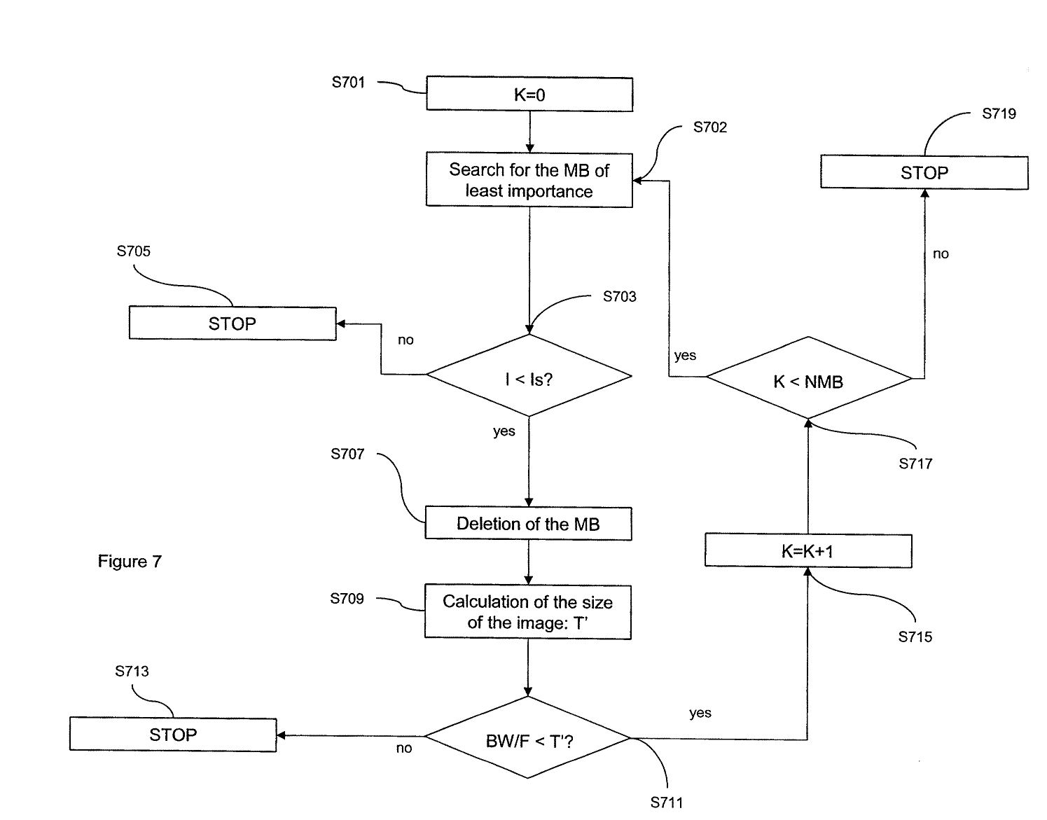

Step S615 is then proceeded to, illustrated by the diagram of FIG. 7, which consists of determining a sub-set of macroblocks such that the size of that sub-set is less than the estimated bandwidth. More particularly, this determination results in the reduction in the size of the image by deletion of macroblocks having the lowest degrees of importance.

The procedure of deleting macroblocks commences at step S701 with the initialization of the variable K to 0.

This variable is used to count down the macroblocks.

Step S701 is followed by step S702 consisting of searching in the map comprising the data representing the degree of importance of the macroblocks of the image, for the macroblock having the lowest degree of importance and which is present, that is to say which has not already been deleted.

This step is followed by the step S703 during which comparison is made between the measurement of the degree of importance I of the macroblock selected at step S702 and the measurement of the predetermined threshold degree of importance obtained from training sequences Is.

If the degree of importance is greater than the threshold degree of importance (I>Is), it is considered that the deletion of that macroblock generates an unacceptable degradation of the video sequence.

In that case, step S703 is followed by step S711 terminating the algorithm without however deleting that macroblock.

In the opposite case, that is to say if the degree of importance is less than the threshold degree of importance (I<Is), step S703 is followed by step S707 consisting of deleting the selected macroblock from the temporary storage unit 53.

In a variant embodiment, that macroblock may be replaced by a macroblock of skipped type, i.e. not coded.

This step S707 is followed by step S709 consisting of calculating the new size T′ of the image to transmit, this new size being calculated on the basis of the sub-set of macroblocks of the image after deletion of a macroblock.

During the following step S711, comparison is made between the new size T′ of the image to transmit and the result of the division of the bandwidth BW by the frame rate F of the video sequence.

If the size T′ of the image is less than the value obtained, the algorithm is terminated by step S713. This is because the size of the image is such that it can be transmitted over the network without risking congestion.

In the opposite case, that is to say when the size T′ of the image is greater than the value obtained, the step S715 is passed on to during which the variable K is incremented by one unit.

Step S715 is followed by step S717 which consists of testing whether the value of the variable K is less than the number of macroblocks of the image.

If the test is positive, step S717 is followed by step S702 already described.

Thus, so long as the size of the sub-set of macroblocks is not compatible with the estimated bandwidth, macroblocks are deleted.

In the opposite case, the algorithm is terminated by the step S719.

According to this algorithm, the video is acted upon by reducing the rate of the sender before losses occur.

In a variant embodiment, it may be considered that, when the algorithm for deleting macroblocks by steps S705 and S719 is left, that deletion procedure is not sufficient to comply with the rate constraint since the size of the image remains too great with respect to the available bandwidth.

In that case, another rate control procedure can be implemented such as a transcoding procedure. This procedure can be implemented further to the deletion procedure provided the bandwidth available on the network has not increased.

This transcoding procedure may consist, for example, in only keeping the images of the sequence coded with the INTRA coding mode.

According to another variant embodiment, on putting into packets at step S611 (FIG. 6), if each macroblock comprises a slice header, the slice header of the first macroblock inserted in the packet can be kept and the slice headers of the other macroblocks of the packet deleted.

In the case of video coded according to the MPEG-4 standard, it is then necessary to modify the macroblock headers so as to enable the prediction of the quantization parameter and of the motion vector of the current macroblock on the basis of the preceding macroblock. It should however be noted that a packet only transports macroblocks which are consecutive in the original image.

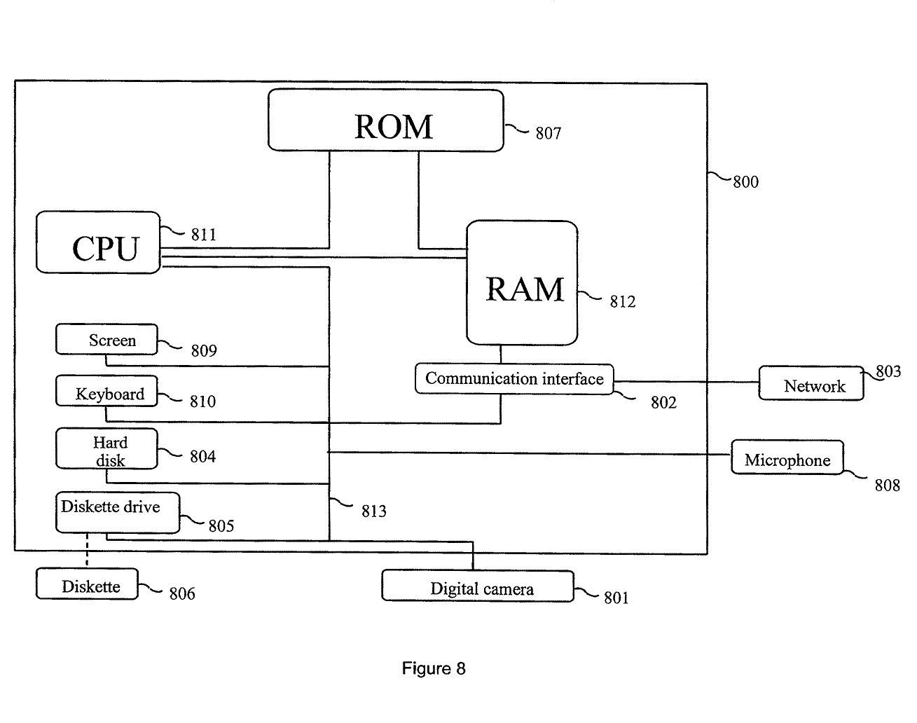

With reference to FIG. 8, a device adapted to operate as a device for generating data representing a degree of importance of data blocks in a coded digital image of a digital video sequence coded in a hybrid predictive video coding format and/or a device for transmitting a video sequence coded in a hybrid predictive video coding format in a communication network according to the invention will now be described in its hardware configuration.

The information processing device of FIG. 8 has all the means necessary for the implementation of the method of generating data representing a degree of importance of data blocks in a coded digital image of a digital video sequence coded in a hybrid predictive video coding format and/or of the method of transmitting a video sequence coded in a hybrid predictive video coding format in a communication network according to the invention.

According to the embodiment chosen, this device may for example be a microcomputer 800 connected to different peripherals, for example a digital camera 801 (or a scanner, or any other image acquisition or storage means) connected to a graphics card and thus supplying the information to be processed according to the invention.

The micro-computer 800 preferably comprises a communication interface 802 connected to a network 803 adapted to transmit digital information. The micro-computer 800 also comprises a storage means 804, such as a hard disk, as well as a diskette drive 805.

The diskette 806 as well as the hard disk 804 can contain software installation data of the invention as well as the code of the invention which, once read by the micro-computer 800, will be stored on the hard disk 804.

According to a variant, the program or programs enabling device 800 to implement the invention are stored in a read only memory ROM 807.

According to another variant, the program or programs are partly or wholly received via the communication network 803 in order to be stored as stated.

The micro-computer 800 may also be connected to a microphone 808 through an input/output card (not shown). The micro-computer 800 also comprises a screen 809 for viewing the information to be processed and/or serving as an interface with the user, so that the user may for example parameterize certain processing modes using the keyboard 810 or any other appropriate means, such as a mouse.

The central processing unit CPU 811 executes the instructions relating to the implementation of the invention, which are stored in the read only memory ROM 807 or in the other storage means described.

On powering up, the processing programs and methods stored in one of the non-volatile memories, for example the ROM 807, are transferred into the random access memory RAM 812, which will then contain the executable code of the invention as well as the variables necessary for implementing the invention.

As a variant, the methods may be stored in different storage locations of the device 800. Generally, an information storage means, which can be read by a computer or microprocessor, integrated or not into the device, and which may possibly be removable, stores a program of which the execution implements the generating and transmitting methods. It is also possible to upgrade the embodiment of the invention, for example, by adding generating and transmitting methods brought up to date or improved that are transmitted by the communication network 803 or loaded via one or more diskettes 806. Naturally, the diskettes 806 may be replaced by any type of information carrier such as CD-ROM, or memory card.

A communication bus 813 enables communication between the different elements of the micro-computer 800 and the elements connected thereto. It will be noted that the representation of the bus 813 is non-limiting. Thus the central processing unit CPU 811 may, for example, communicate instructions to any element of the micro-computer 800, directly or via another element of the micro-computer 800.

Of course, the present invention is in no way limited to the embodiments described and represented, but encompasses, on the contrary, any variant form within the capability of the person skilled in the art.

1. A method of generating data representing a degree of importance of data blocks in a coded digital image of a digital video sequence coded in a hybrid predictive video coding format, said image being divided into a plurality of data blocks, the method comprising, for the data blocks of the image, a step of determination of data representing the degree of importance of each of those data blocks on the basis of the coding or absence of coding of said data block, the determination also depending on the possible use of the data block considered for the coding of at least one data block of at least one other image of the video sequence.

2. A method according to claim 1, wherein, in case of coding of the data block, the determination is furthermore a function of the coding mode used.

3. A method according to claim 2, wherein the coding mode of said data block is an INTRA or INTER coding mode.

4. A method according to claim 1, wherein the determination depending on the possible use of the data block is carried out on a set of images comprising at least one image consecutive to the image considered in the sequence.

5. A method according to claim 1, wherein the determination of data representing the degree of importance I_{MB}_{_{t,i}} is carried out by means of the following equation:
$${I}_{{MB}_{t , i}} = α {\sum }_{j} ( \frac{1}{{σ}_{{MB}_{t + 1 , j}}} \times \frac{{p}_{{MB}_{t + 1 , j} ∈ {MB}_{t , i}}}{{P}_{T} \times {I}_{{MB}_{t + 1 , j}}} )$$
where the block t+1,j is at least partially predicted from the block t,i,
σ_{MB}_{_{t+1,j}} is the variance of the prediction error for the current block,
p_{MB}_{_{t+1,j}}_{εMB}_{_{t,i}} is the number of pixels of the reference block MB_{t,i} used on prediction of the current block MB_{t+1,j},
P_{T} is the number of pixels in a block, and
α is a multiplying factor.

6. A method according to claim 5, wherein the multiplying factor a takes a first value when the coding mode of said data block is an INTRA coding mode and a second value when the coding mode of said data block is a coding mode different from the INTRA mode, the first value being greater than the second value.

7. A method according to claim 1 comprising a step of generating a map comprising the data representing the degree of importance of data blocks of the image considered.

8. A method according to claim 1, wherein the degree of importance of a data block increases with the use of that data block for the coding of data blocks of other images.

9. A method according to claim 1, wherein the degree of importance of a data block coded independently of other data blocks of other images is higher than that of a data block coded in a manner dependent on other data blocks of other images.

10. A method according to claim 1, wherein the non-coded data blocks of the image have a low degree of importance.

11. A method of transmitting a video sequence coded in a hybrid predictive video coding format in a communication network, the video sequence being composed of a plurality of digital images, each image being divided into a plurality of data blocks, wherein, with data blocks of the images there are associated data representing a degree of importance of each of the data blocks, the method comprising the following steps applied to images of the video sequence to transmit:
estimating the bandwidth of the communication network,
comparing the size of the image to transmit with the estimated bandwidth,
according to the result of the comparison, deciding as to the determination of a sub-set of data blocks of the image each having a degree of importance chosen from the highest degrees of importance, such that the size of that sub-set is compatible with the estimated bandwidth, and
according to the result of the comparison, transmitting the image or the determined sub-set of data blocks of the image.

12. A method of transmitting a video sequence coded in a hybrid predictive video coding format in a communication network the video sequence being composed of a plurality of digital images each image being divided into a plurality of data blocks wherein, with data blocks of the images there are associated data representing a degree of importance of each of the data blocks the method comprising the following steps applied to images of the video sequence to transmit:
estimating the bandwidth of the communication network
comparing the size of the image to transmit with the estimated bandwidth
according to the result of the comparison deciding as to the determination of a sub-set of data blocks of the image each having a degree of importance chosen from the highest degrees of importance such that the size of that sub-set is compatible with the estimated bandwidth and
according to the result of the comparison transmitting the image or the determined sub-set of data blocks of the image
wherein the degree of importance is determined according to the method of generating data according to any one of claims 1 to 10.

13. A method of transmitting a coded video sequence according to claim 11, comprising a step of coding blocks in video packet form.

14. A method of transmitting a coded video sequence according to claim 11, wherein the determination of a sub-set of data blocks of the image comprises the deletion of data blocks in increasing order of the degrees of importance.

15. A method of transmitting a coded video sequence according to claim 14, wherein the deletion of the data blocks of increasing degree of importance is carried out so long as the data representing the degree of importance of the data blocks are less than a predetermined threshold.

16. A method of transmitting a coded video sequence according to claim 14, wherein the deletion of the data blocks of increasing degree of importance is carried out so long as the size of that sub-set of data blocks of the image is not compatible with the estimated bandwidth.

17. A device for generating data representing a degree of importance of data blocks in a coded digital image of a digital video sequence coded in a hybrid predictive video coding format, said image being divided into a plurality of data blocks, wherein the device comprises means for determination of data representing the degree of importance of data blocks on the basis of the coding or absence of coding of said data block, the determination also depending on the possible use of the data block considered for the coding of at least one data block of at least one other image of the video sequence.

18. A device according to claim 17, wherein, in case of coding of the data block, the determination means are furthermore adapted to determine data as a function of the coding mode used.

19. A device according to claim 18, wherein the coding mode of said data block is an INTRA or INTER coding mode.

20. A device according to claim 17, wherein the determination means are adapted to carry out the determination of the possible use of the data block on a set of images comprising at least one image consecutive to the image considered in the sequence.

21. A device according to claim 17, comprising means for generating a map comprising the data representing the degree of importance of data blocks of the image considered.

22. A device according to claim 17, wherein the degree of importance of a data block increases with the use of that data block for the coding of data blocks of other images.

23. A device according to claim 17, wherein the degree of importance of a data block coded independently of other data blocks of other images is higher than that of a data block coded in a manner dependent on other data blocks of other images.

24. A device according to claim 17, wherein the non-coded data blocks of the image have a low degree of importance.

25. A device for transmitting a video sequence coded in a hybrid predictive video coding format in a communication network, the video sequence being composed of a plurality of digital images, each image being divided into a plurality of data blocks, wherein, with data blocks of the images there are associated data representing a degree of importance of each of the data blocks, the device comprising the following means applied to images of the video sequence to transmit:
estimating means adapted to estimate the bandwidth of the communication network,
comparing means adapted to compare the size of the image to transmit with the estimated bandwidth,
deciding means adapted to decide, according to the result of the comparison, as to the determination of a sub-set of data blocks of the image each having a degree of importance chosen from the highest degrees of importance, such that the size of that sub-set is compatible with the estimated bandwidth, and
transmitting means adapted to transmit, according to the result of the comparison, the image or the determined sub-set of data blocks of the image.

26. A device for transmitting a video sequence coded in a hybrid predictive video coding format in a communication network the video sequence being composed of a plurality of digital images each image being divided into a plurality of data blocks, wherein, with data blocks of the images there are associated data representing a degree of importance of each of the data blocks, the device comprising the following means applied to images of the video sequence to transmit:
estimating means adapted to estimate the bandwidth of the communication network
comparing means adapted to compare the size of the image to transmit with the estimated bandwidth
deciding means adapted to decide, according to the result of the comparison as to the determination of a sub-set of data blocks of the image each having a degree of importance chosen from the highest degrees of importance such that the size of that sub-set is compatible with the estimated bandwidth and
transmitting means adapted to transmit according to the result of the comparison the image or the determined sub-set of data blocks of the image,
wherein the degree of importance is determined by the device for generating data according to claim 17.

27. A device for transmitting a coded video sequence according to claim 25, comprising means for coding blocks in video packet form.

28. A device for transmitting a coded video sequence according to claim 25, wherein the means for determination of a sub-set of data blocks of the image comprise means for deletion of data blocks in increasing order of the degrees of importance.

29. A computer program that can be loaded into a computer system, said program containing instructions enabling the implementation of the method of generating data representing a degree of importance of data blocks in a coded digital image of a digital video sequence coded in a hybrid predictive video coding format according to claim 1, when that program is loaded and executed by a computer system.

30. A computer program that can be loaded into a computer system, said program containing instructions enabling the implementation of the method of transmitting a video sequence coded in a hybrid predictive video coding format in a communication network according to claim 11, when that program is loaded and executed by a computer system.
